(19) United States
(12) Patent Application Publication
(10) Pub. No.: US 2025/0360469 A1
(43) Pub. Date: Nov. 27, 2025

(54) AERATOR AND CARBONDIOXIDE SEPARATOR

(71) Applicant: N P Innovation AB, Malmö (SE)

(72) Inventors: Nils-Åke PERSSON, Malmö (SE); Fredrik BERGLING, Skäret (SE)

(21) Appl. No.: 18/874,351

(22) PCT Filed: Jun. 20, 2023
(86) PCT No.: PCT/SE2023/050632

§ 371 Date: Dec. 12, 2024

(30) Foreign Application Priority Data
Jun. 23, 2022 (SE) 2250784-2

(51) Int. Cl. B01F 23/234; B01D 19/00; B01F 101/00; C02F 1/20; C02F 1/74; C02F 101/10; C02F 103/20

(52) U.S. Cl. CPC B01F 23/23412; B01D 19/0005; B01D 19/0047; C02F 1/20; C02F 1/74; B01F 2101/305; B01F 2215/0422; B01F 2215/0427; B01F 2215/0431; C02F 2101/10; C02F 2103/20; C02F 2301/024

(57) ABSTRACT

A device (100) for aeration of and separation of carbon dioxide from a fluid is disclosed. The device comprises at least a first and a second screen gear (101,102) said first and second screen gear (101,102) comprising several screen windows (203) in the form of openings. The shape and/or distribution of said screen windows (203) on said first and second screen gear (101,102), when said first and second screen gear (101,102) are connected, is such that at least 20%, preferably at least 25%, more preferably at least 30%, of the screen windows (203) of the first screen gear (101) are asymmetrically distributed in relation to the screen windows (203) of the second screen gear (102), asymmetrically distributed implying that the edges surrounding the screen windows of the first screen gear are not 100% overlapping the edges of the screen windows of the second screen gear when the first and second screen gear are connected and seen from above.

### FIELD OF THE INVENTION

The present invention relates to a device for aeration of and separation of carbon dioxide from a fluid.

The present invention also relates to a system and a method for aeration of and separation of carbon dioxide from a fluid.

### BACKGROUND ART

For fish breeding in fish tanks with a focus on sustainability it is of utmost importance that the system is a closed system, which minimizes the discharge to the surrounding environment.

For traditional closed systems, the water in the fish tanks is lead out and is conventionally then filtered in a drum filter, a disc filter or a bio-filter system for cleaning of the water. The water is then often aerated and the carbon dioxide is separated from the water before it is returned to the fish tank.

Traditional aerators and carbon dioxide separators usually consist of an air feed system which creates bubbles and puts the water in motion. This type of air feed system, however, suffers from the drawback that they have a low degree of efficiency. They also suffer from the drawback of strong biological growth on the surfaces of the aerator.

Other aerators of known type may be made of blocks of thin plastic, which comprise built-in passages to create thin flows of water meeting the surrounding air. These blocks are superimposed, creating a stack, but suffer from the drawback that the blocks are not kept clean, but get covered with biological growth over time, resulting in an efficacy that is decreasing with time due to the extended biological growth.

Other aerators may comprise a screen gear, where the screen gear may suffer from the drawback that it does not provide a high enough degree of efficiency.

Most aerators known today do not incorporate aeration and separation of carbon dioxide from a fluid within one device or system. For instance, U.S. Pat. No. 2,633,343 describes a solution related to a fluid mixing device and more particularly to a device for producing a stream of liquid containing air bubbled throughout the stream. Furthermore, U.S. Pat. No. 6,270,022 describes an aerating device for a multiple jet shower. The purpose of said aerating device is to produce a more pleasing sensation.

### SUMMARY OF THE INVENTION

The aim of the present invention is thus to solve the problems mentioned above with aerators and carbon dioxide separators suffering from biological growth and low efficacy, which may be decreasing over time.

According to the present invention this is done by providing a device for aeration of and separation of carbon dioxide from a fluid, said device comprising at least a first and a second screen gear, said first and second screen gear comprising several screen windows in the form of openings, wherein the shape and/or distribution of said screen windows on said first and second screen gear, when said first and second screen gear are connected, is such that at least 20%, preferably at least 25%, more preferably at least 30% of the screen windows of the first screen gear are asymmetrically distributed in relation to the screen windows of the second screen gear, asymmetrically distributed implying that the edges surrounding the screen windows of the first screen gear are not 100% overlapping the edges of the screen windows of the second screen gear when the first and second screen gear are connected and seen from above.

According to an aspect at least 35%, 40%, 45%, 50%, 55%, 60%, 65%, 70%, 75%, 80%, 85%. 90%, 95% or 100% of the screen windows of the first screen gear are asymmetrically distributed in relation to the screen windows of the second screen gear.

According to an aspect said first and second screen gear may be rotated 90°, or alternatively 180°, in relation to each other when said first and second screen gear are connected. In relation to this it should be noted that these rotation degrees should only be seen as possible alternatives according to the present invention.

According to yet another embodiment of the present invention, the device comprises at least three screen gears, and wherein a coverage area of the screen material in a vertical Z-direction for said at least three screen gears, when being connected to each other, is at least 70%, preferably at least 80%. According to yet another embodiment of the present invention, the device comprises at least four screen gears, and wherein a coverage area of the screen material in a vertical Z-direction for said at least four screen gears, when being connected to each other, is at least 80%, preferably at least 90%.

The present invention provides a device for aeration of and separation of carbon dioxide from a fluid in which there is possible to obtain both a high level of coverage area of the screen material in a vertical Z-direction, but which at the same time has a high level of total free area of each screen gear. This is preferred according to the present invention as this provides both long contact time and contact distance for aeration of and separation of carbon dioxide from the water flow, but which at the same time provides a high level of total free area ensuring a high capacity of flow of water and air through the device and thus a high yield of aeration of and separation of carbon dioxide.

In line with the above, according to one embodiment of the present invention, a total free area of each screen gear, defined by all a sum of screen windows, is at least 50%, preferably at least 70% for each screen gear.

Furthermore, and linked to the combination mentioned above, according to yet another embodiment of the present invention, the device comprises at least three screen gears, and wherein a coverage area of the screen material in a vertical Z-direction for said at least three screen gears, when being connected to each other, is at least 70%, preferably at least 80%, and wherein a total free area of each screen gear, defined by all a sum of screen windows, is at least 50%, preferably at least 70% for each screen gear.

According to yet another embodiment of the present invention, the device comprises multiple screen gears which are stacked to one another providing a tube with outer openings only at the ends of the tube. One such example is shown in FIG. 10A. There it may be seen that screen gears stacked to one another is arranged as a tube which is only open at its ends. Such a tube provides an improved air flow in a device for aeration of and separation of carbon dioxide from a fluid according to the present invention. Moreover, it should also be noted that preferably the stacked screen gears are rotated in relation to each other one and one when being connected to each other and stacked, e.g. rotated 90° or 180°, such as described above and below.

According to yet another aspect of the present invention, said screen windows are of triangular, rectangular, square, pentagonal, hexagonal, heptagonal, and/or octagonal shape, preferably rectangular or square shape.

According to an aspect said first and second screen gear each comprises a frame and a grid.

According to an aspect said screen windows on said first and second screen gear are positioned on said grid.

According to an aspect the area of said screen windows is larger on one side of said screen gear than on the other side of said screen gear.

According to an aspect said grid of said first screen gear is separated by a distance of 10-250 mm from said grid of said second screen gear.

According to an aspect the side of said screen gear with the smaller screen windows faces the fluid when the fluid first meets said first and second screen gear.

According to an aspect at least one side of said screen windows has a length of 10-50 mm, preferably 20 mm.

According to an aspect said frame and grid of said first and second screen gear are detachable from each other.

According to an aspect said frame and grid of said first and second screen gear are locked together by a first locking device.

According to an aspect said first locking device is of snap fit type.

According to an aspect said first and second screen gear are locked together by a second locking device for locking in at least one direction.

According to an aspect the device may be locked to at least another device by a third locking device.

According to an aspect said first and second screen gear are provided with means for attaching said second locking device.

According to an aspect said first and second screen gear consist of non-porous substrates, preferably plastic or metal.

According to an aspect the fluid is water, preferably water from fish tanks.

According to an aspect the screen windows on said first and second screen gear are distributed in at least three parallel rows, and wherein a width of at least one such row of screen windows differs from the width of at least one of the at least two remaining rows of screen windows.

According to an aspect, provided is further a system for aeration of and separation of carbon dioxide from a fluid, comprising a device according to the present invention.

According to an aspect the system further comprises a fan for removal of the separated carbon dioxide from the system.

According to an aspect the system may further comprise at least one inlet chute distributing the fluid homogenously over said first and/or second screen gear.

According to a further aspect, provided is also a method for aeration and separation of carbon dioxide from a fluid, using a device according to the present invention, comprising the steps of providing a fluid to the device, allowing the fluid to be transported through the device by gravity, and collecting the fluid, having a decreased amount of carbon dioxide and/or an increased amount of oxygen.

According to an aspect the fluid is water, preferably water from fish tanks.

### BRIEF DESCRIPTION OF THE DRAWINGS

FIG. 1 shows a schematic design of a first and a second screen gear of a device for aeration and carbon dioxide separation according to the invention, said first and second screen gear comprising several screen windows.

FIG. 2 is a view from above of a grid of a first and second screen gear, the grid comprising multiple rows of screen windows.

FIG. 3 is a side view of a frame of a first and second screen gear according to the present invention.

FIG. 4 is a view from above of a frame of a first and second screen gear, where the grid has been removed.

FIG. 5 is a view from above of at least a first and second screen gear when connected to each other. The grid pattern as seen from above is tight since the screen windows are distributed assymetrically on the first and second screen gear.

FIGS. 6A-6C show examples of details of a first and second screen gear, where the frame and grid thereof are locked together by a first locking device, said first locking device being of snap fit type.

FIG. 7 is a view of several devices according to the invention, comprising multiple of said first and second screen gear.

FIG. 8 is a view of a device being locked together with another device by a third locking device. This gives stability to multiple devices standing next to each other.

FIG. 9 is a detailed view of an example of a third locking device according to the present invention.

FIG. 10A is a view of a device according to the present invention comprising multiple first and second screen gears, further comprising two of said second locking device for easier handling.

FIG. 10B is a detailed view of the second locking device shown in FIG. 10A.

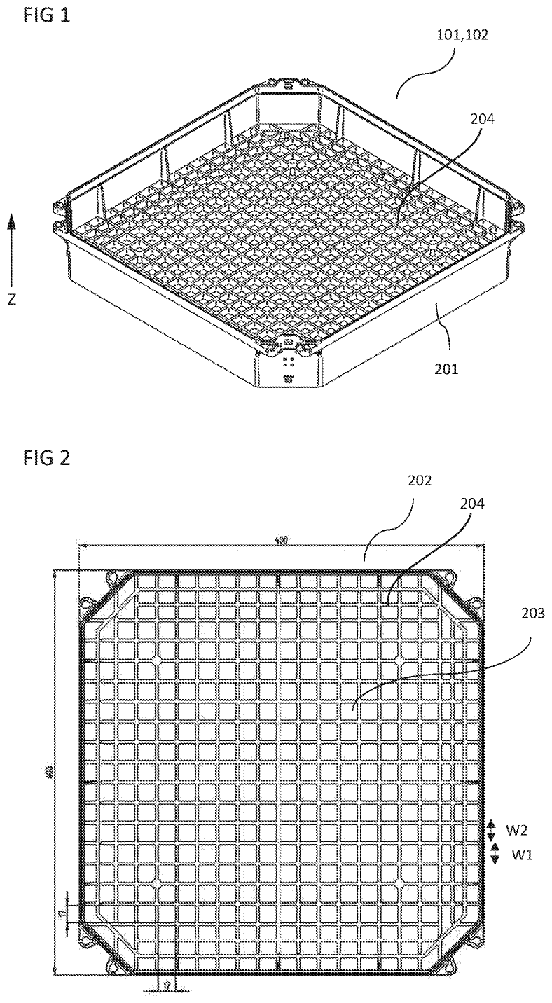

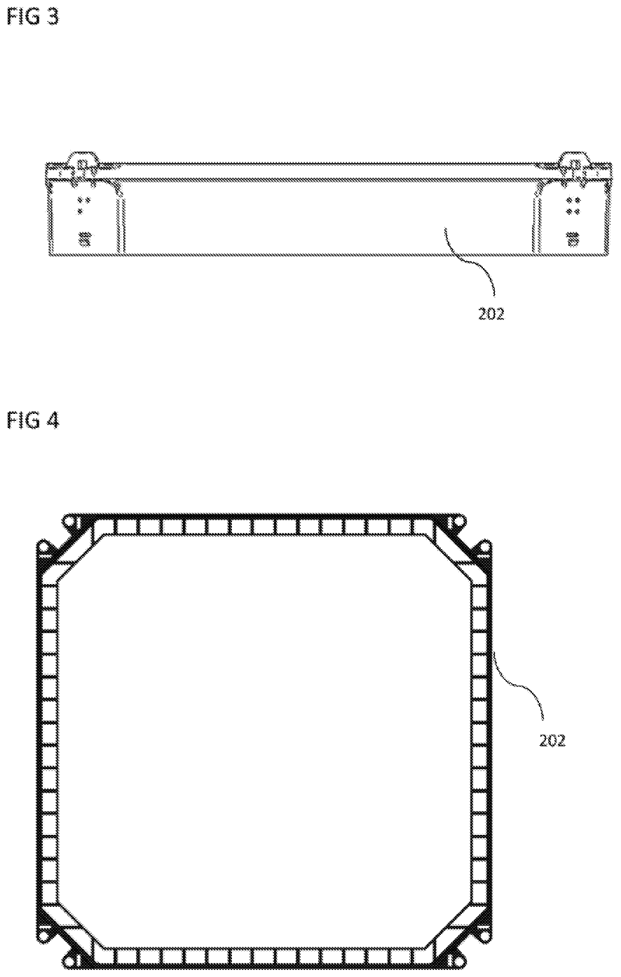

### DETAILED DESCRIPTION OF THE INVENTION

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example aspects may be implemented at least in part by means of both hardware and software, and that several “means”, “units” or “devices” may be represented by the same item of hardware.

When the screen windows of the first screen gear are “assymetrically” distributed in relation to the screen windows of the second screen gear, the edges surrounding the screen windows of the first screen gear are not 100% overlapping the edges of the screen windows of the second screen gear when the first and second screen gear are connected and seen from above.

At least 20%, 25%, 30%, 35%, 40%, 45%, 50%, 55%, 60%, 65%, 70%, 75%, 80%, 85%. 90%, 95% or 100% of the screen windows of the first screen gear may be asymmetrically distributed in relation to the screen windows of the second screen gear.

The different aspects, alternatives and embodiments of the invention disclosed herein can be combined with one or more of the other aspects, alternatives and embodiments described herein. Two or more aspects can be combined.

As stated above, the present invention relates to a device 100 for aeration of and separation of carbon dioxide from a fluid, said device comprising at least a first and a second screen gear 101,102 said first and second screen gear 101,102 comprising several screen windows 203 in the form of openings. The shape and/or distribution of said screen windows 203 on said first and second screen gear 101,102, when said first and second screen gear 101,102 are connected, is such that at least 20%, preferably at least 25%, more preferably at least 30% of the screen windows 203 of the first screen gear 101 are asymmetrically distributed in relation to the screen windows 203 of the second screen gear 102. This can be seen if the first and second screen gear 101,102, when connected, are seen from above, as shown in FIG. 5. As stated, said device comprises at least a first and a second screen gear 101, 102, more preferably at least three, at least four, at least five, at least six, at least seven, at least eight, at least nine, at least ten, at least fifteen, at least twenty, at least thirty or more of said first and/or second screen gears 101, 102. The effect of the aeration and carbon dioxide separation increases with an increased number of first and second screen gear 101,102, where a device 100 comprising for instance ten first and/or second screen gear 101,102 gives a better aeration of, and carbon dioxide separation from, the fluid, e.g., water, than a device 100 comprising two of said first and second screen gear 101,102.

Said first and second screen gear 101, 102 of the device 100 may be rotated 90°, or alternatively 180°, in relation to each other when said first and second screen gear 101,102 are connected. Each first and/or second screen gear 101,102 may comprise several screen windows 203, preferably at least three, more preferably at least four, at least five, at least six, at least seven, at least eight, at least nine, at least 10, at least 20, at least 30, at least 40, at least 50, at least 60, at least 70, at least 80, at least 90, at least 100, at least 150, at least 200, at least 250, at least 500, at least 1000, at least 5000 or more, screen windows 203. The screen windows 203 may be of triangular, rectangular, square, pentagonal, hexagonal, heptagonal, and/or octagonal shape, preferably rectangular or square shape.

Said first and second screen gear 101,102 may each comprise a frame 201 and a grid 202. The screen windows 203 on said first and second screen gear 101, 102 may be positioned on the grid 202.

The area of said screen windows 203 may be larger on one side of said first and second screen gear 101,102 than on the other side of said first and second screen gear 101,102. The side of said first and second screen gear 101,102 with the smaller area of said screen window/windows 203 preferably faces the fluid when the fluid first meets the first and/or second screen gear 101,102, i.e. the smaller area of the screen window 203 faces upwards, while the larger area of the screen window 203 faces downwards. The fact that the screen windows 203 are tapered in accordance with the above creates a diffusor effect that contributes to a higher volume of throughput per surface area of the device 100. The total surface area of the screen windows 203 on the first and second screen gear 101,102 on the side of the first and/or second screen gear 101,102 with the smaller area of said screen windows 203, when the screen windows are tapered, or if the screen windows 203 are not tapered-any side of the first and/or second screen gear 101,102, is preferably 60-90% of the total area of the first and/or second screen gear 101,102, more preferably around 70%.

The grid 202 of said first screen gear 101 may be separated by a distance of 10-250 mm from said grid 202 of said second screen gear 102.

At least one side of said screen windows 203 may have a length of 10-50 mm, preferably about 20 mm. The screen windows 203, when being of square shape, preferably have a dimension of between 10×10 mm to 50×50 mm, with a preferred dimension of 20×20 mm. The depth of each screen window 203 is preferably within the range of 5-40 mm.

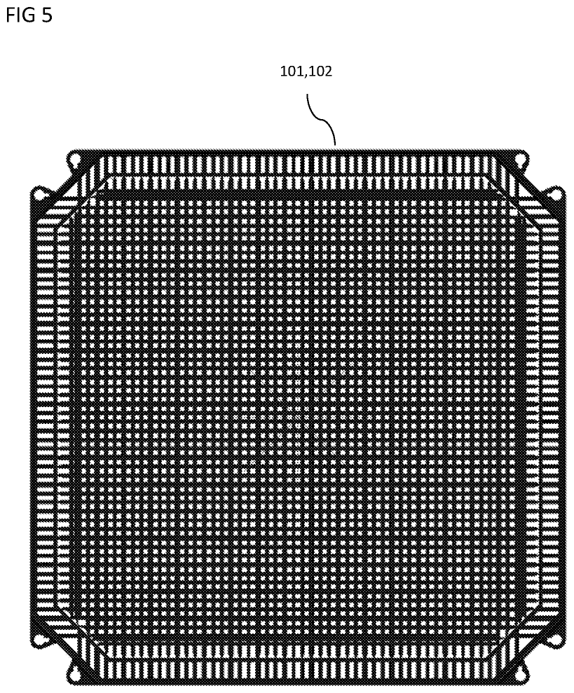

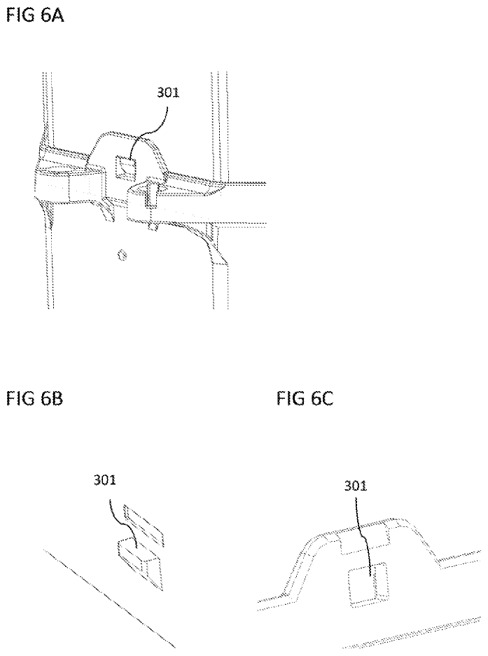

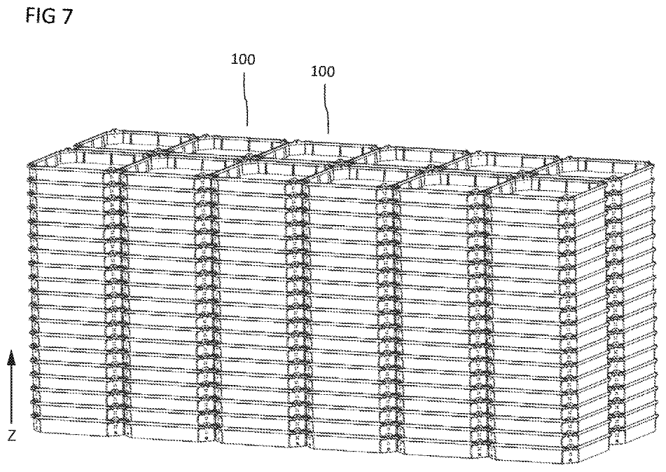

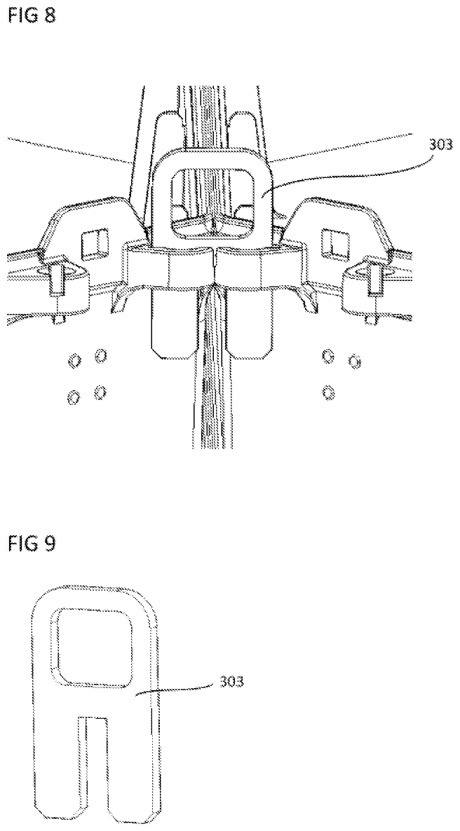

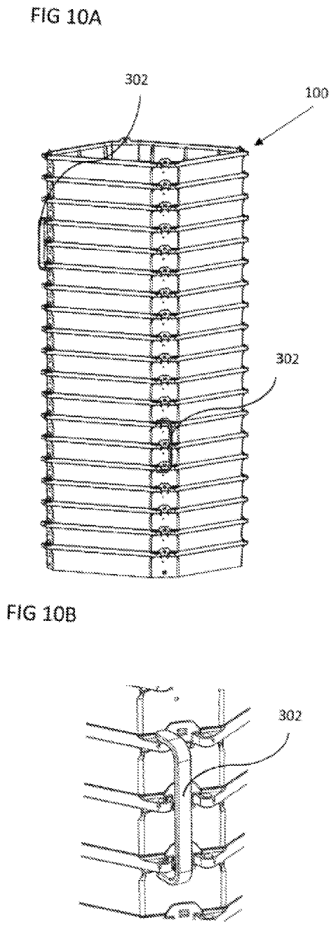

The frame 201 and grid 202 of said first and second screen gear 101, 102 may be detachable from each other. This can be seen in FIG. 4, showing the frame 201 where the grid 202 has been removed from the frame 201. The frame 201 and grid 202 of said first and second screen gear 101,102 may further be locked together by a first locking device 301. The first locking device 301 may be of snap fit type. This can be seen in FIG. 6.

The first and second screen gear 101,102 may be locked together by a second locking device 302 for locking in at least one direction. The second locking device 302 may also act as a handle to make the handling and carrying of the first and second screen gear 101,102 easier. The first and second screen gear 101,102 may be provided with means for attaching said second locking device 302 to said first and second screen gear 101,102.

The first and second screen gear 101,102 are preferably perpendicular, or essentially perpendicular, in relation to the direction of he flow of fluid that hits and passes them.

The device 100 may be locked to at least another device 100 by a third locking device 303. The third locking device 303 preferably locks one device 100 to another device 100 in at least two directions.

The first and second screen gear 101,102 of the device 100 are preferably made of non-porous substrates, preferably plastic or metal, to avoid penetration of fluid, such as water, and to make it more difficult for biological growth to occur. Biological growth on the device 100 is also hindered by the strong turbulence created by the stream of fluid, preferably water.

The fluid for which the present invention is intended is preferably water, more preferably water from fish tanks.

The screen windows 203 on said first and second screen gear 101,102 may be distributed in at least three parallel rows, wherein a width W1 of at least one such row of screen windows 203 may differ from the width W2 of at least one of the at least two remaining rows of screen windows 203. If the width W1 differs from the width W2, the result may be that if a first and second screen gear 101, 102 are connected, and the first screen gear 101 is rotated 90° or 180° in relation to the second screen gear 102, the screen windows 203 of the first screen gear 101 may be asymmetrically distributed in relation to the screen windows 203 of the second screen gear 102.

The present invention also relates to a system for aeration of and separation of carbon dioxide from a fluid. The system comprises a device 100 according to the above. The system may comprise a fan for removal of the separated carbon dioxide from the system. The system may further comprise at least one inlet chute distributing the fluid homogenously over said first and/or second screen gear 101,102.

The present invention also relates to a method for aeration and separation of carbon dioxide from a fluid, using a device 100 according to the above. The method may comprise the steps of providing a fluid to the device 100, allowing the fluid to be transported through the device 100 by gravity, and collecting the fluid, having a decreased amount of carbon dioxide and/or an increased amount of oxygen. The fluid may be water, preferably water from fish tanks.

To obtain an optimal efficiency, the incoming flow of fluid, preferably water, may be distributed through specific inlet chutes constructed to distribute the fluid evenly over the device 100. The flow of fluid, preferably water, from the inlet chutes and on to the device 100, is preferably done through perforated chutes so that the water is distributed evenly on the device 100.

As the fluid flows down through the first and second screen gear 101,102 of the device 100, the flow of fluid drags a lot of air along, which air is mixed with the fluid upon the impact of the fluid with the first and second screen gear 101,102, on the fluid's way down to the bottom of the device 100.

Preferably, the chutes delivering fluid to the device 100 according to the present invention are more narrow/smaller than the width of the first and second screen gear 101,102, creating free spaces along the sides to allow for the fluid to, without hindrance, drag air into the device 100. Preferably, the chute delivering fluid to the device 100 covers about 60% of the area of the first and/or second screen gear 101,102 closest to the chute, and the remaining about 40% of the surface of the screen gear 101 is free, allowing for the air to be drawn down through the device 100.

The strong turbulence and the amount of free fluid surfaces, preferably water droplets, that are created as the fluid meets the first and second screen gear 101, 102 on its way down through the device 100 gives a very efficient aeration, and at the same time efficient release of carbon dioxide. The carbon dioxide is preferably removed from the device 100 along the side of the first and second screen gear 101, 102, or, alternatively, at the bottom of the device 100, after passing the first and second screen gear 101,102. It is of great importance that the premises where the device 100 is situated are well ventilated, or that the carbon dioxide that has been separated from the fluid is led through a ventilation system and thereby removed from the premises. A fan may be used to remove separated carbon dioxide from the device 100.

To avoid that small droplets of fluid are transferred out/lost from the stream of fluid, the air that has passed the fan may be led through a droplet separator, removing the droplets, allowing this to be returned to the flow of fluid, reducing the effect of the humidity on the surrounding system.

The amount of carbon dioxide that is separated from the fluid by the device 100 according to the present invention is about 45-70% of the carbon dioxide present in the fluid, and is typically 60% of the carbon dioxide in the fluid.

1-28. (canceled)

29. A device for aeration of and separation of carbon dioxide from a fluid, said device comprising at least a first and a second screen gear said first and second screen gear comprising several screen windows in the form of openings, wherein the shape and/or distribution of said screen windows on said first and second screen gear, when said first and second screen gear are connected, is such that at least 20%, preferably at least 25%, more preferably at least 30% of the screen windows of the first screen gear are asymmetrically distributed in relation to the screen windows of the second screen gear, asymmetrically distributed implying that the edges surrounding the screen windows of the first screen gear are not 100% overlapping the edges of the screen windows of the second screen gear when the first and second screen gear are connected and seen from above.

30. The device according to claim 29, wherein said first and second screen gear are rotated 90°, or alternatively 180°, in relation to each other when said first and second screen gear are connected.

31. The device according to claim 29, wherein the device comprises at least three screen gears, and wherein a coverage area of the screen material in a vertical Z-direction for said at least three screen gears, when being connected to each other, is at least 70%, preferably at least 80%.

32. The device according to claim 29, wherein the device comprises at least four screen gears, and wherein a coverage area of the screen material in a vertical Z-direction for said at least four screen gears, when being connected to each other, is at least 80%, preferably at least 90%.

33. The device according to claim 29, wherein a total free area of each screen gear, defined by all a sum of screen windows, is at least 50%, preferably at least 70% for each screen gear.

34. The device according to claim 29, wherein the device comprises at least three screen gears, and wherein a coverage area of the screen material in a vertical Z-direction for said at least three screen gears, when being connected to each other, is at least 70%, preferably at least 80%, and wherein a total free area of each screen gear, defined by all a sum of screen windows, is at least 50%, preferably at least 70% for each screen gear.

35. The device according to claim 29, wherein the device comprises multiple screen gears which are stacked to one another providing a tube with outer openings only at the ends of the tube.

36. The device according to claim 29, wherein said screen windows are of triangular, rectangular, square, pentagonal, hexagonal, heptagonal, and/or octagonal shape, preferably rectangular or square shape.

37. The device according to claim 29, wherein said first and second screen gear each comprises a frame and a grid, preferably said screen windows on said first and second screen gear are positioned on said grid, preferably said grid of said first screen gear is separated by a distance of 10-250 mm from said grid of said second screen gear.

38. The device according to claim 29, wherein the area of said screen windows is larger on one side of said screen gear than on the other side of said screen gear, preferably the side of said screen gear with the smaller screen windows faces the fluid when the fluid first meets said first and second screen gear.

39. The device according to claim 29, wherein at least one side of said screen windows has a length of 10-50 mm, preferably 20 mm.

40. The device according to claim 37, wherein said frame and grid of said first and second screen gear are detachable from each other.

41. The device according to claim 37, wherein said frame and grid of said first and second screen gear are locked together by a first locking device, preferably said first locking device is of snap fit type.

42. The device according to claim 29, wherein said first and second screen gear are locked together by a second locking device for locking in at least one direction.

43. The device according to claim 29, wherein the device may be locked to at least another device by a third locking device.

44. The device according to claim 42, wherein said first and second screen gear are provided with means for attaching said second locking device to said first and second screen gear.

45. The device according to claim 29, wherein said first and second screen gear consist of non-porous substrates, preferably plastic or metal.

46. The device according to claim 29, wherein the fluid is water, preferably water from fish tanks.

47. The device according to claim 29, wherein said screen windows on said first and second screen gear are distributed in at least three parallel rows, and wherein a first width of at least one such row of screen windows differs from a second width of at least one of the at least two remaining rows of screen windows.

48. A system for aeration of and separation of carbon dioxide from a fluid, comprising a device according to claim 29, preferably comprising a fan for removal of the separated carbon dioxide from the system, preferably comprising at least one inlet chute distributing the fluid homogenously over said first and/or second screen gear.
